(19) United States
(12) Patent Application Publication
(10) Pub. No.: US 2002/0091597 A1
(43) Pub. Date: Jul. 11, 2002

(54) Method and system of using invoice categorization in accounting management application

(76) Inventor: Kuan-Min Teng, Taipei City (TW)

Correspondence Address: Jason Z. Lin, 19597 Via Monte Drive, Saratoga, CA, 95070, US

(21) Appl. No.: 09/757,039

(22) Filed: Jan. 9, 2001

(51) Int. Cl. G06F 17/60

(52) U.S. Cl. 705/30

(57) ABSTRACT

This invention is an application of “Invoice Categorization” in accounting management system. It could replace the numerous entries such as sub-items and details used in traditional accounting and make the accounting works more user friendly.

This invention improves the deficits in handling multi-level management, enhances management controls and simplifies difficult accounting functions. Armed with “Invoice Categorization ”, companies could consolidate their Enterprise Resource Planning (ERP) sub-systems with their accounting management system easily and effectively.

### BACKGROUND OF THE INVENTION

1. Field of the Invention

This invention relates generally to a computer system designed for accounting application, more particularly, it relates to a method that applies “Invoice Categorization” as management tools to record and categorize accounting data.

2. Description of the Prior Art

“Invoice” is the “Voucher of Transaction” of accounting data in computer systems. It is also the foundation of composing financial reports. Therefore, it is absolutely important to secure the accuracy of invoicing.

In traditional invoicing, the invoices need to capture items such as: Mr. John Doe, the person in charge, posted a recruiting advertisement on X newspaper on Sep. 9, 2000. Received invoice number: AZ02312339. Invoice date: Sep. 9, 2000. It is chargeable to Home appliance unit, Marketing department. Pay date: Sep. 30, 2000. etc.

As a result, transactions need to be categorized into sub-items and details. The chart of accounts could easily content more than thousands of accounts if looking into every detail. It is almost impossible for accountants to memorize every account. The situation is worsening if the computer system were not responsive to user inquiries. The invoicing efficiency is negatively impacted consequently.

Sometimes, an account needs to content multiple sets of sub-items or details for management purpose. This kind of flexibility is not applicable in traditional accounting system. It would be also a nightmare when composing Profit/Loss Analysis Tables such as Profit/Loss Table, Gross Profit Table. As a result, the traditional invoicing is just incapable to consolidate with ERP system.

The traditional invoice categorization could only describe a summary. So, it could not take advantage of invoice categorization to make itemized inquiries.

In traditional invoice making, an account is limited to content only one set of sub-items or details. Otherwise, discrepancies are inevitable during consolidation.

In traditional invoice making, accountants have to match account names or specific conditions to do consolidation.

In traditional invoice making, it is not applicable to provide an inquiry or print out a detailed report for a single or specific condition.

As noted the abovesaid prior arts, this invention provides a specific, systematic, unified and standardized invoice categorization which beyond the reach of traditional accounting.

By pinpointing the exact meaning of every invoices category, this invention maneuvers accounting works more concisely and effectively. By using “Invoice Categorization” to categorize and analyze a chart of accounts, companies could consolidate their accounting management system with their ERP and, therefore, enhance their management.

First, a few accounting terms need to be defined and explained. In academic accounting, “Transactions” is defined as accounting activities. “Accounting Process” is defined as the process to handle transactions. “Invoice Categorization” is defined as the process to categorize data into necessary elements on an invoice. This invention applies the concept of database management and data dictionary to make invoice categorization specific and systematic.

“Invoice” is the “Voucher of Transaction” of accounting data in computer systems. It is also the foundation of composing financial reports. Therefore, it is absolutely important to secure the accuracy of invoicing.

Since traditional invoice only contents descriptive summaries, so, accounting systems could not abstract itemized messages from the written description to further analyze or audit transactions.

On the flip side of the coin, it would be just impossible for accountants to memorize every account if a chart of accounts would maximized its depth to capture every detail. More efforts would be devoted while more errors would happen. The invoicing efficiency is negatively impacted consequently.

Sometimes, an account needs to content multiple sets of sub-items or details for management purpose. This kind of flexibility is not applicable in traditional accounting system. It would be also a nightmare when composing Profit/Loss Analysis Tables such as Profit/Loss Table and Gross Profit Table. As a result, the traditional invoicing is just incapable to consolidate with ERP system.

### SUMMARY OF THE INVENTION

The object of this invention is to provide solutions to the disadvantages and problems of traditional accounting and to offer benefits such as the followings:

To breakdown the descriptive summary in traditional invoice into specific, systematic, unified and standardized invoice categories. While, collectively, the information in the categories would reflect the true meaning in the invoice summary.

To provide excellent flexibility to modify invoice contents any time.

To provide various ways to sort and analyze data in invoice categories and to enhance management functions.

To increase both invoicing speed and accuracy.

To enable an account to content multiple sets of sub-items or details and to enrich the essential information for decision-making.

To boost up overall productivity.

To consolidate Enterprise Resource Planning (ERP) sub-systems with accounting management system easily and effectively.

For more detailed information regarding this invention together with further advantages or features thereof, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 indicates the traditional accounting process;

FIG. 2 illustrates the designed flow chart of how invoice categorization is used in this invention;

FIG. 3A illustrates the steps to set up invoice categories;

FIG. 3B indicates an example of using invoice category dictionary and the chart of accounts to set up the invoice categories for each account.;

FIG. 3C shows an example of how invoice categorization is used to create the elements in the corresponding account for future consolidation as well as to create the detailed account groups in a chart of accounts;

FIG. 3D indicates an example of how the consolidation elements are used to generate detailed report and unconsolidated amount report;

FIG. 3E shows an example of the unconsolidated amount report for accounts 1144: accounts receivable;

FIG. 3F indicates how different detailed ledgers could be made by different needs and how the data period could be appointed; and

FIG. 3G shows an example of how invoice categories: “clients” and “department” were combined as sorting criteria in generating a detailed ledger for accounts 1144: accounts receivable.

### DETAILED DESCRIPTION OF THE PREFERRED EMBODIMENT

A whole bunch of unsorted data is useless for analysis in computer data process. Therefore, data need to be digitalized and categorized before computers could analyze them and turn them into useful information.

Due to the low speed and high cost of manual process as well as the increasing power of computer technology, people no longer just use computer to “digitalize” the original voucher. Rather, people expect their computer systems could effectively process data as well as turn the processed data into useful information and accounting report.

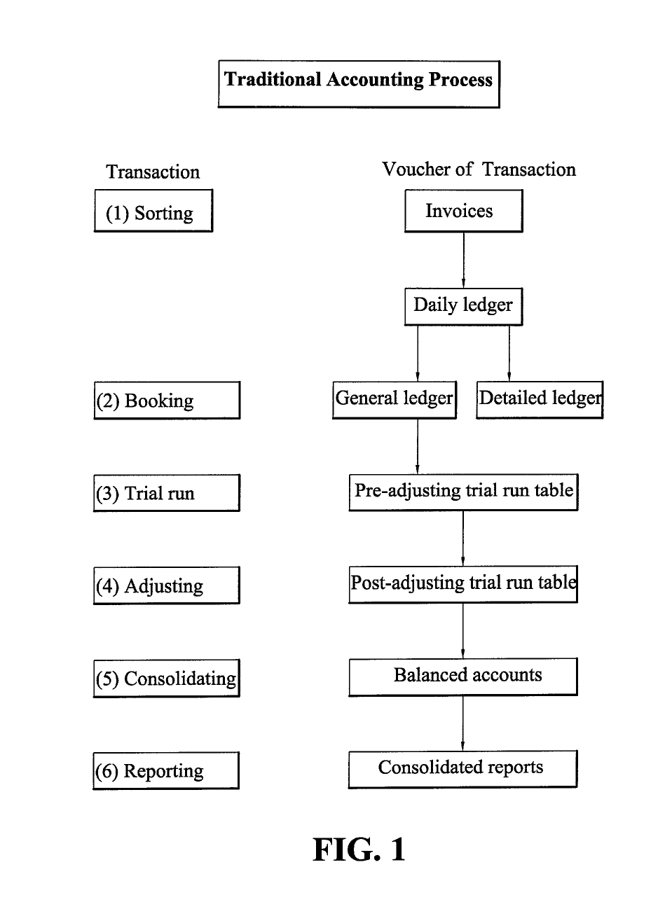

The traditional accounting process includes six steps (1) Sorting, (2) Booking, (3) Trial run, (4) Adjusting, (5) Consolidating and (6) Reporting (See FIG. 1). Sorting is the process to make accounting vouchers (invoices) and record them onto dated books (Daily ledger). Booking is the process to record transactions to the proper accounts (General ledger and Detailed Ledger). Trial run is the process to test any booking errors (Pre-adjusting Trial run table). Adjusting is the process to adjust each account rationally (Post-adjusting Trial run table. Consolidating is the process to close dull accounts and balance active accounts (Balanced accounts). Reporting is the process to compose all kinds of consolidated reports (Consolidated reports)

Since “Invoice” is the “Voucher of Transaction” of accounting data in computer systems and is also the foundation of composing financial reports, it is absolutely important to secure the accuracy of invoicing. However, since traditional invoices only content descriptive summaries, so, accounting systems could not abstract itemized messages from the written description to further analyze or audit transactions.

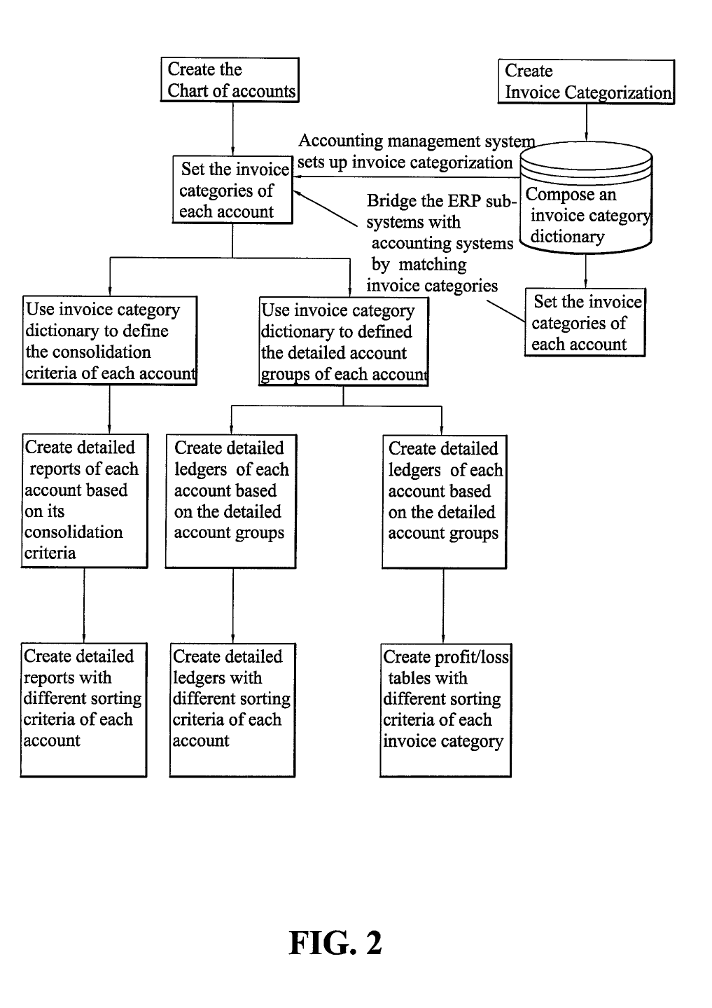

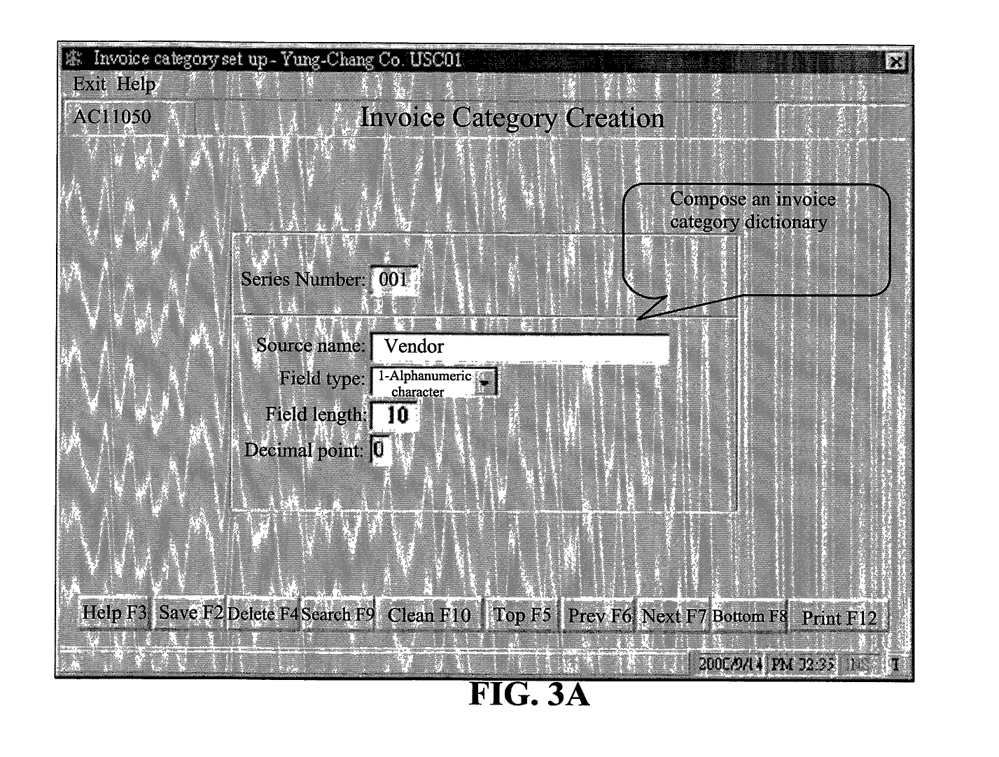

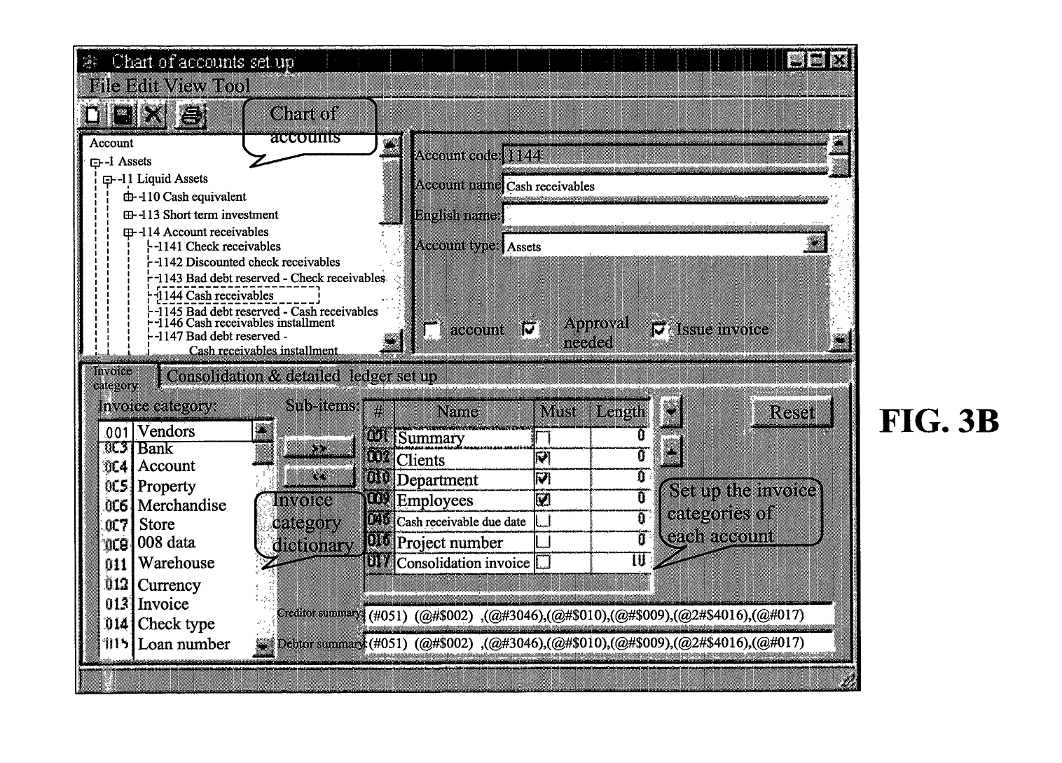

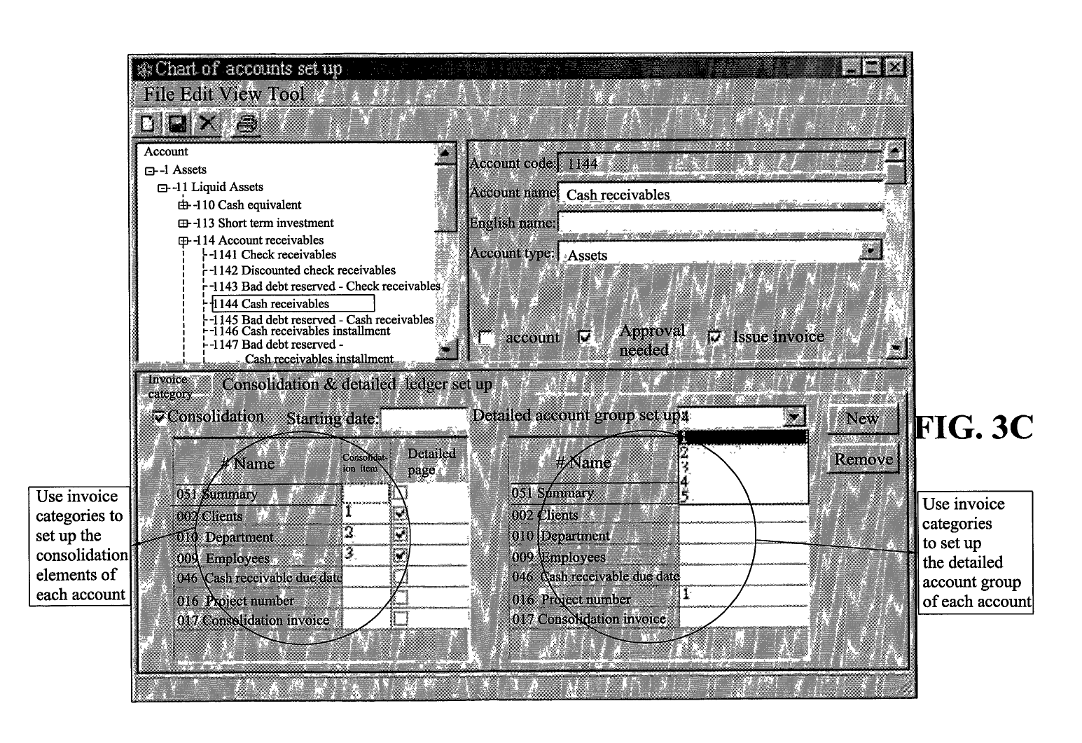

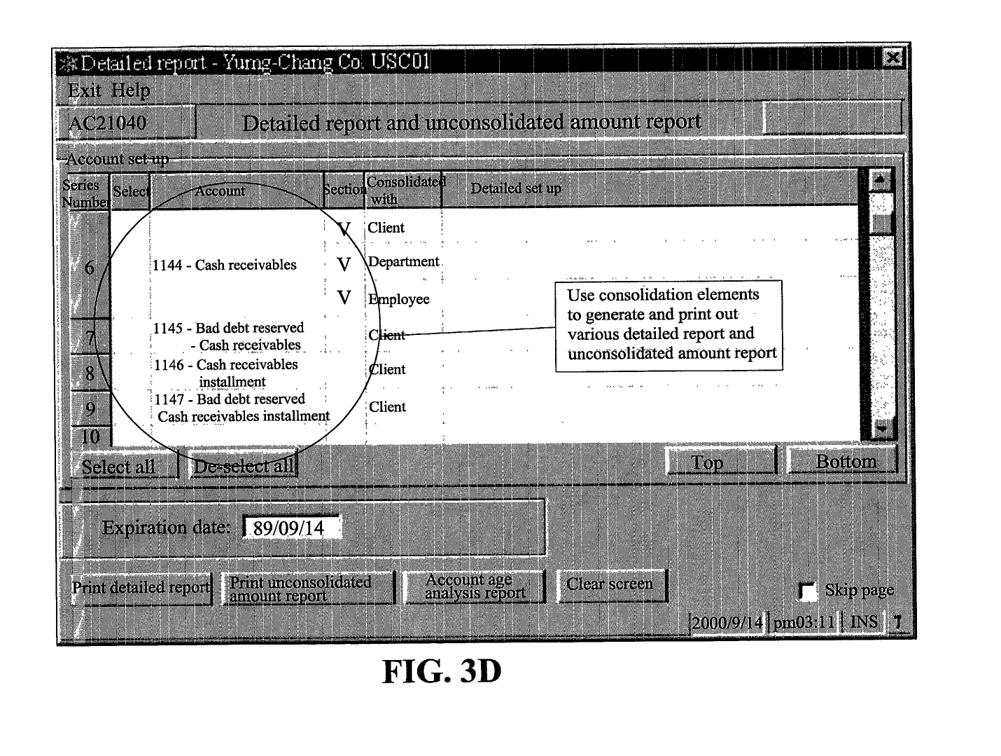

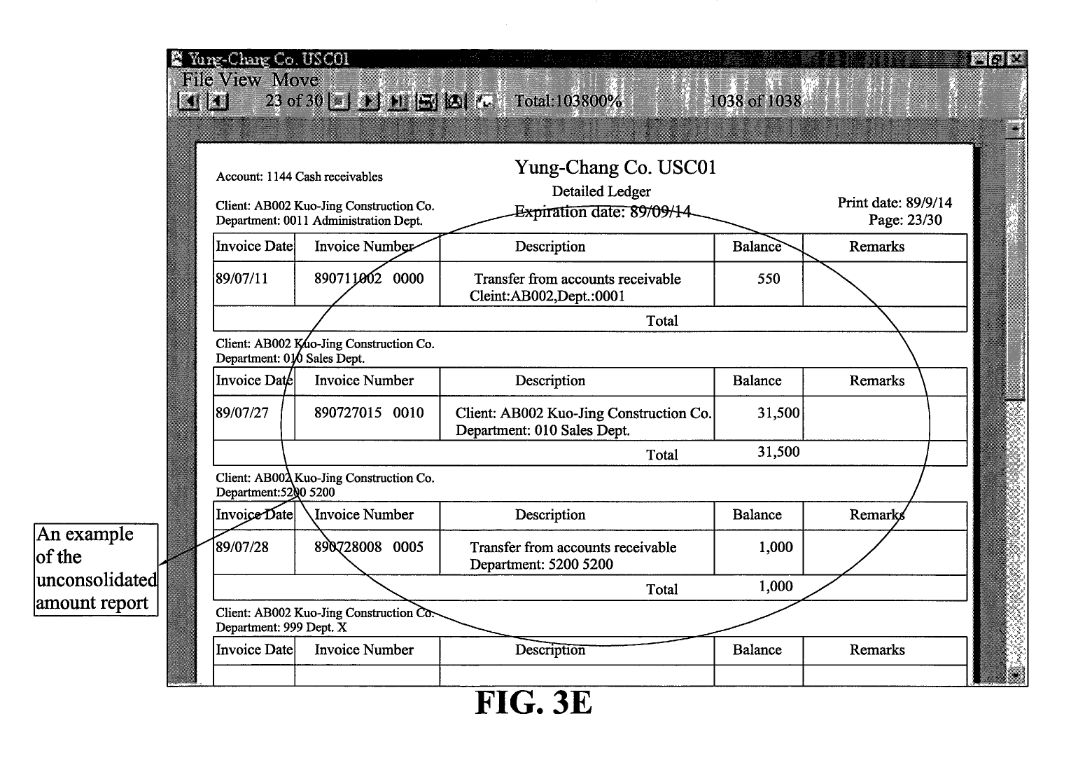

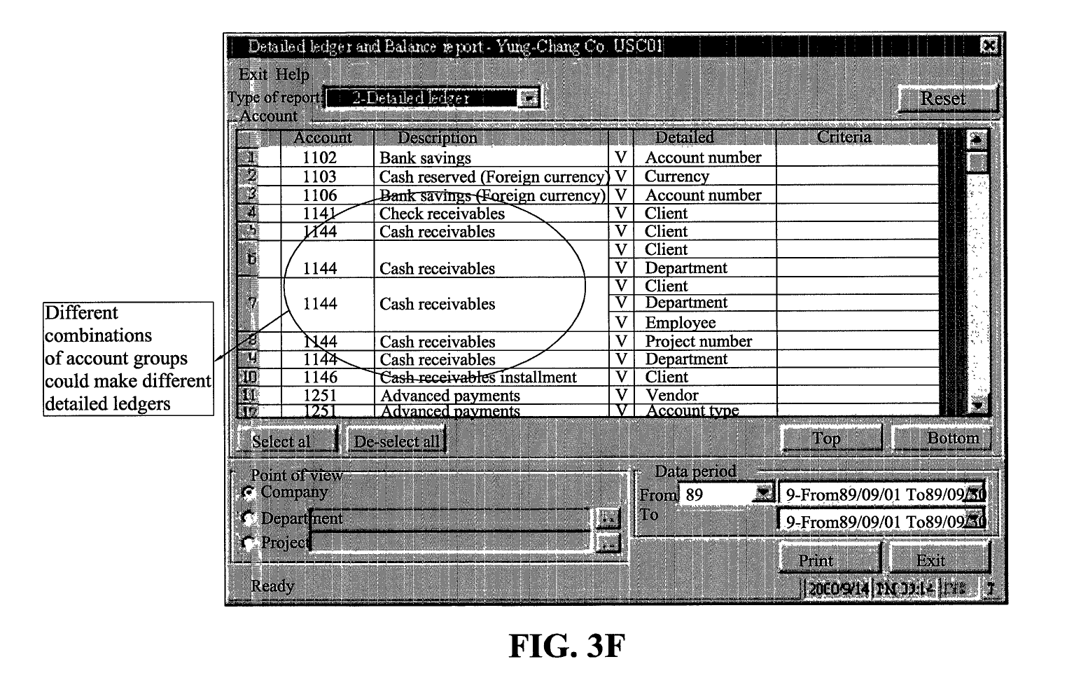

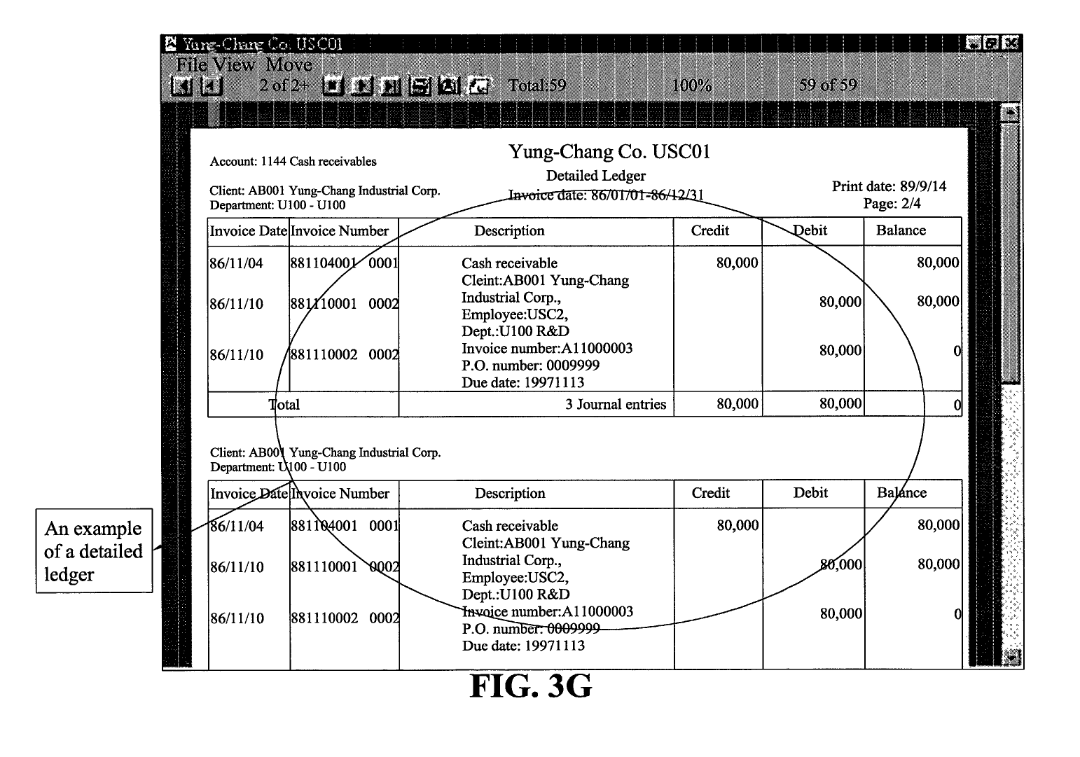

FIG. 2 and FIG. 3 demonstrate an example of the advantages to apply this invention. FIG. 2 shows the designed flow chart of how invoice categorization is used in this invention. First, invoice categories need to be set up in order to compose an invoice category dictionary. With the end of mind, it would be wise to use each ERP sub-system to set up matching invoice category accordingly. So, invoices could be issued easily from the related invoice category for any ERP sub-system later on.

FIG. 3A shows the steps to set up invoice categories. The user needs to enter proper data sequentially in order to compose an invoice category dictionary. The key is to use each ERP sub-system to set up matching invoice category accordingly. Consequently, invoices could be easily issued from the related invoice category for any ERP sub-system later on.

Once the invoice categories were set up and an invoice category dictionary was composed, the next step is to set up the invoice categories for each account. FIG. 3B shows an example of using invoice category dictionary and the chart of accounts to set up the invoice categories for each account.

The followings are the explanation of how a chart of accounts is defined. Traditionally, accounting defines the hierarchy of a chart of accounts into five “levels.” The first level is classification; the second level is specification; the third level is account; the forth level is sub-items, and the fifth level is the details, i.e.: person name or product name. The General Accepted Accounting Principles (GAAP) further breaks down the first level into nine categories assets, liabilities, shareholder's equity, operational income, operational costs, operational expenses, non-operational income and expenses, special operational profit/loss and income tax/profit. However, there are only four levels in this system.

FIG. 3B shows an example of a chart of accounts. The code “1 assets” is a “classification” and belongs to the first level; “11 liquid assets” is a “specification” and belongs to the second level; “114 accounts receivable” is an “account” and belongs to the third level; where “1144 cash receivable” is a “sub-items” and belongs to the forth level.

The bottom of FIG. 3B shows the elements in invoice categorization denoted along with their 3-digit codes and descriptions. For example: 001 stands for vendors; 002 stands for clients; 009 stands for employees; 010 stands for departments; 016 stands for project number; 017 stands for consolidation invoice; 046 stands for cash receivable due date; 051 stands for summary, etc. The highlighted “1144 cash receivable” in the chart of accounts stands for it consists of invoice categorization elements such as 051, 002, 010, 009, 046, 016, 017.

As shown in the above example, “Invoice Categorization” is the building bricks of an invoice. By using the “data dictionary” concept, computer systems can be used to implement database management and define invoice categorization specifically and systematically. For example: the invoice categorization elements for “cash payable” are [payee] [expected pay date] [invoice received] [invoice received date] [chargeable to department] [chargeable to project] [person in charge] [transaction item] [summary], etc. For another example: the invoice categorization elements for “cash receivable” are [clients] [expected receivable date] [invoice issued] [invoice issued date] [sales item] [sales department] [salesperson] [project] [summary]. For another example: the invoice categorization elements for “sales revenue” are [clients] [sales item] [sales department] [salesperson] [project] [summary]

Since traditional invoices only content descriptive summaries, so, there is no sufficient invoice categorization to further assist user inquiries. However, this invention applies systematic and specific ways to create an invoice and make it easier to sort and manage data by the invoice categories. Let's review the example previously shown in the background of the invention:

[transaction description]: A recruiting advertisement was posted on X newspaper on Sep. 9, 2000

[transaction item]: FF001a◯◯ recruiting advertisement

[payee]: 23293422a◯◯ X newspaper

[expected pay date]: Sep. 30, 2000

[invoice received]: AZ02312339

[invoice received date]: Sep. 9, 2000

[chargeable to department]: U020a sales department

[chargeable to project]: B010a Home appliance unit [person in charge]: USC1a◯◯◯

Contrasting to traditional invoice categorization, this invention could use the elements in invoice categorization to find out corresponding accounting items. For example: use the field [payee] to find out payee; use the field [expected pay date] to find out expected pay date; use the field [invoice received] to find out the invoice number of the invoice received; use the field [invoice received date] to find out invoice received date; use the field [chargeable to department] to find out the department to be charged to; use the field [ chargeable to project] to find out the project to be charged to; use the field [person in charge] to find out the person in charge; and use the field [transaction item] to find out the transaction item.

There is an important equation in accounting: assets+expense=liabilities+equity+profit. So, this equation can be used to balance the related fields in invoice categorization. This “balancing” process could also help verifying if there is any error in recording and if any adjustment is needed to rationalize entries. If recording errors were identified or accounts were unable to be balanced, accounts could trace back and find out the errors, such as wrong amounts or wrong transaction items, and correct them.

There are two kinds of “Chart of Accounts” in business accounting: “Asset/Liability Table” and “Profit/Loss Table.” “Asset/Liability Table” is classified into assets, liabilities and shareholder's equity; where “Profit/Loss Table” is classified into operational income, operational costs, operational expenses, non-operational income and expenses, special operational profit/loss and income tax/profit.

Now, let's look into FIG. 3C and 3E. FIG. 3C shows an example of how invoice categorization is used to create the elements in the corresponding account for future consolidation as well as to create the detailed account groups in a chart of accounts. The example use invoice categorization to create the elements of consolidation for account 1144, accounts receivable, as the followings:

051 summary, 002 clients, 010 department, 009 employee, 046 cash receivable due date, 016 project number, and 017 invoice issued. The example also set up a detailed account group 4 to identify those elements of consolidation for account 1144.

In traditional invoice categorization, only one set of sub-items and details can be listed under each account; for example: 2147. 23293422. U020. B010. Otherwise, consolidation discrepancies may happen. However, this invention could use the invoice categorization of an account to combine and create several sets of sub-items and details which is much more powerful than using only one set of sub-items and details. For example: [payee], or [chargeable to department], or [transaction item], or [person in charge], or [payee] and [chargeable to department], or [payee] and [chargeable to project], or [payee], [chargeable to department] and [chargeable to project] demonstrate a few combinations of different sub-items and details for consolidation.

In traditional invoice categorization, only account details or specific conditions can be used to consolidate accounts. FIG. 3D shows an example of how the consolidation elements are used to generate detailed report and unconsolidated amount report.

FIG. 3E shows an example of the unconsolidated amount report for accounts 1144: accounts receivable. As long as the invoice category dictionary had defined the detailed account groups of every account in the chart of accounts, this invention could use the invoice categories in an account to combine different consolidation elements and print out various detailed ledgers for every account. For example: detailed ledgers made by combinations such as [payee], or [chargeable to department], or [chargeable to project], or [transaction item], or [person in charge], or [payee] and [chargeable to department] or [payee] and [chargeable to project] or [payee], [chargeable to department] and [chargeable to project], etc.

This invention could also select a specific invoice category, use invoice category dictionary to define the consolidation elements of each account, and use these consolidation elements to generate various detailed ledgers. FIG. 3F shows an example of how various detailed ledgers could be generated by appointing the beginning and ending date period: Sep. 1, 1989-Sep. 30, 1989.

FIG. 3F also shows how different detailed ledgers could be made by different needs and how the data period could be appointed.

FIG. 3G shows an example of how invoice categories: “clients” and “department” were combined as sorting criteria in generating a detailed ledger for accounts 1144: accounts receivable.

The following will show how cash payable ledgers cold be variable by different sorting criteria. For example: (1) cash payable ledger (by payee), (2) cash payable ledger (by department to be charged), (3) cash payable ledger (by project to be charged), (4) cash payable ledger (by transaction item), (5) cash payable ledger (by person in charge), (6) cash payable ledger (by payee and department to be charged), (7) cash payable ledger (by payee and project to be charged), (8) cash payable ledger (by payee, department to be charged and project to be charged), etc.

Since the invoice category dictionary had set up the detailed account groups for each account, this invention could also select and combine invoice categories to generate various Profit/Loss Tables. For example: Profit/Loss Table of the entire conglomerate, Profit/Loss Table of the whole cooperation, Profit/Loss Table of departments, Profit/Loss Table of projects, Profit/Loss Table of sales items, Profit/Loss Table of employees, Profit/Loss Table of departments and projects, Profit/Loss Table of departments, employees and sales items, etc.

On the same token, once the chart of accounts is defined, this invention could set up the invoice category dictionary and then, use accounting management system to create invoice categories. This invention could also bridge the ERP sub-systems with accounting systems by matching invoice categories, communicate their data and set up the invoice categories for every account accordingly. By selecting various ways of invoice categorization, this invention could generate and print out various reports needed for accounting system. For example: daily ledger, cash ledger, procurements ledger, sales ledger and general ledger, etc.

Comparing to traditional invoice categorization, this invention requires less accounts in the chart of accounts and issues invoices faster. This invention could easily generate and print out various reports based on different combinations of invoice categories. This invention is easier and more flexible to consolidate data with ERP systems. This invention uses invoice categorization to bridge the data among sub-systems in ERP and makes those sub-systems tightly bonded.

From the experts' point of view, the examples shown above by no means provide an exhausted list of the benefits of this invention as well as the limits of its patent application. Any equitable modification or variation that derives from the idea of this invention is all inclusively protected under this patent application scope.

What is claimed is:

1. A method of using invoice categorization for setting up a chart of accounts, comprising the following steps:
dividing invoice categories into independent data fields;
classifying the descriptive summary in the invoice to the data fields;
inputting data to matching invoice category fields;
selecting the invoice categories for each account;
appointing the invoice categories as sub-items and details for each account.

2. The method according to claim 1, wherein the invoice categories for each account can replace the sub-items and details.

3. The method according to claim 1, wherein the account can have several the sub-items and the details at the same time.

4. The method according to claim 1, further comprising the step of setting up a dictionary of the invoice categories.

5. The method according to claim 1, further comprising the step of using the invoice categories to provide invoice data for user inquiries.

6. The method according to claim 1, further comprising the step of selecting one or more the invoice categories as criteria for consolidating accounts.

7. The method according to claim 1, further comprising the step of inputting criteria to categorize a chart of accounts for setting up summaries.

8. The method according to claim 1, further comprising the steps of including criteria to categorize a chart of accounts for setting up sub-category summaries.

9. The method according to claim 1, further comprising the steps of displaying the fields as selection criteria and picking up the fields for a specific invoice category of an account.

10. The method according to claim 1, further comprising the steps of entering data to the invoice categories fields and generating corresponding reports.

11. The method according to claim 1, further comprising the steps of displaying and printing out corresponding reports.

12. The method according to claim 11, wherein the corresponding reports at least have accounting management system reports such as daily ledger, general ledger, detailed ledger, detailed entries, profit/loss table, asset/liability table, profit/loss comparison table, and asset/liability comparison table.

13. The method according to claim 1, further comprising the step of generating detailed report and unconsolidated amount report based on one or more combinations of the invoice categories.

14. The method according to claim 1, further comprising the step of generating detailed ledger based on one or more combinations of the invoice categories.

15. The method according to claim 1, further comprising the step of generating profit/loss table and profit/loss comparison table based on one or more combinations of the invoice categories.

16. The method according to claim 1, further comprising the step of generating asset/liability table and asset/liability comparison table based on one or more combinations of the invoice categories.

17. An accounting management system of applying the method according to claim 1, said system could use the contents and nature of transaction invoices to create proper invoice categories and then apply the invoice categories to consolidate data with other ERP systems.
